(19) United States
(12) Patent Application Publication
(10) Pub. No.: US 2007/0155337 A1
(43) Pub. Date: Jul. 5, 2007

(54) Method and apparatus for scheduling in a communication system

(75) Inventors: Jang-Won Park, Seongnam-si (KR); Young-Soon Lee, Yongin-si (KR); Byung-Chan Ahn, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/649,021

(22) Filed: Jan. 3, 2007

(30) Foreign Application Priority Data
Jan. 2, 2006 (KR) 287-2006

(51) Int. Cl. H04B 7/00

(52) U.S. Cl. 455/69; 455/522; 455/63.1

(57) ABSTRACT

Disclosed is a scheduling method in a communication system including a plurality of mobile stations (MSs) and a base station (BS) for providing a communication service to the MSs. The scheduling method includes determining candidate transmission formats of the MSs according to channel status information fed back from the MSs and levels of transmission power of the MSs; and calculating priorities of the determined candidated transmission formats, and determining a transmission format having the highest priority among the candidated transmission formats, as a transmission format for each of the MSs.

### PRIORITY

This application claims benefit under 35 U.S.C. § 119(a) of a Korean Patent Application filed in the Korean Intellectual Property Office on Jan. 2, 2006 and assigned Serial No. 2006-287, the entire disclosure of which is incorporated herein by reference.

### BACKGROUND OF THE INVENTION

1. Field of the Invention

The present invention relates generally to a communication system, and in particular, to a method and apparatus for scheduling in a Broadband Wireless Access (BWA) communication system.

2. Description of the Related Art

Active research is on going in the next generation communication system, to provide high-speed services having various Qualities of Service (QoS) to users. Particularly, high-speed services that can guarantee mobility and QoS for a Broadband Wireless Access (BWA) communication system such as a Wireless Local Area Network (WLAN) system and a Wireless Metropolitan Area Network (WMAN) system is currently under study. The Institute of Electrical and Electronics Engineers (IEEE) 802.16a/d communication system and an IEEE 802.16e communication system are typical BWA communication systems.

The IEEE 802.16a/d communication system and IEEE 802.16e communication system are communication systems employing Orthogonal Frequency Division Multiplexing (OFDM)/Orthogonal Frequency Division Multiple Access (OFDMA) to support broadband transmission network for physical channels of the WMAN system. The IEEE 802.16a/d communication system currently considers only the state where a subscriber station (SS) is fixed, i.e. the state where mobility of the SS is never considered, and the single-cell structure. Unlike the IEEE 802.16a/d communication system, the IEEE 802.16e communication system considers mobility of the SS of the IEEE 802.16a communication system, and an SS having mobility will herein be referred to as a mobile station (MS).

The IEEE 802.16e communication system, which is the BWA communication system, has a frame structure. A base station (BS) efficiently allocates resources of each frame to MSs and transmits the resource allocation information to the MSs through a MAP message. A MAP message used for transmitting downlink (DL) resource allocation information is referred to as a DL-MAP message, and a MAP message used for transmitting uplink (UL) resource allocation information is referred to as a UL-MAP message.

If the BS transmits downlink resource allocation information and uplink resource allocation information through the DL-MAP message and the UL-MAP message, the MSs can decode the DL-MAP message and the UL-MAP message transmitted by the BS. The MSs then detect allocation positions of resources allocated to them, and control information of the data that they should receive. The MSs can receive and transmit data through downlink and uplink messages by detecting the resource allocation position and the control information.

The MAP message is composed of different MAP Information Element (IE) formats according to whether it is for the downlink or the uplink, and according to the type of its data bursts, i.e. according to whether the data bursts are Hybrid Automatic Repeat reQuest (HARQ) data bursts, non-HARQ data bursts, or control information. Therefore, the MSs should be designed to recognize the format of each MAP IE in order to decode the MAP IE. If the MAP IE is for the downlink, the MSs can identify the MAP IE using a Downlink Interval Usage Code (DIUC), and if the MAP IE is for the uplink, the MSs can identify the MAP IE using an Uplink Interval Usage Code (UIUC).

As described above, in the BWA communication system, data transmission is performed in units of frames, and each frame is divided into a region for transmitting downlink data and a region for transmitting uplink data. The region for transmitting uplink data is formed in a 2-dimensional arrangement of a frequency region versus a time region, and each element of the 2-dimensional arrangement is a slot, which is an allocation unit. For each slot, the frequency region is divided into subchannels, each of which is a bundle of subcarriers, and the time region is divided into 3 symbols. Therefore, the slot represents a region where one subchannel occupies 3 symbols. Each slot is allocated to only one MS among the MSs located in one cell, and a set of slots allocated to each of the MSs located in the cell is a burst. In this communication system, uplink wireless resources are allocated in such a manner that slots are separately used by MSs.

In the uplink of the existing communication systems, for example, the Code Division Multiple Access (CDMA) communication system and the Wideband Code Division Multiple Access (WCDMA) communication system, a signal transmitted from one MS serves as an interference component to other MSs. The CDMA communication system and the WCDMA communication system use a control scheme in which signals transmitted by all MSs are received at the BS with the same reception power regardless of channel statuses between the BS and the MSs.

However, in the CDMA communication system and the WCDMA communication system, the control scheme for allowing signals transmitted by all MSs to be received at the BS with the same reception power regardless of channel statuses between the BS and the MSs is inefficient in that transmission power resource of an MS having a good channel status to the BS cannot be fully used. Therefore, the BS receives Channel Quality Information (CQI) fed back from MSs through a Channel Quality Information Channel (CQICH), estimates the channel status, for example, Carrier-to-Interference and Noise Ratio (CINR), of the downlink using the received CQI, and performs scheduling according to the estimated channel status.

In other words, in the CDMA communication system and the WCDMA communication system, downlink scheduling includes selecting a CQI having the highest data rate among the CQIs satisfying the estimated CINR, and determining a transmission format having the lowest transmission power or the lowest coding rate among the selected CQIs. The term “transmission format” refers to a Modulation and Coding Scheme (MCS) level to be used for providing a communication service to MSs, and the number of slots to be allocated to each of the MSs. In the CDMA communication system and the WCDMA communication system, uplink scheduling is performed using a rate control scheme of increasing or decreasing the data rate of each of MSs according to loading on a circuit basis.

However, such scheduling may have problems, when it is applied to the next generation communication system for providing various high-speed QoSs, for example, the communication system employing OFDM/OFDMA (“OFDM/OFDMA communication system”). More specifically, the uplink of the OFDM/OFDMA communication system estimates the channel status through the CQIs fed back from MSs to a BS during previous transmission, and controls loading of the MSs, taking the system loading into account through the estimated channel status. At this point, the uplink of the OFDM/OFDMA communication system determines the transmission format satisfying the system loading control, using a non-HARQ MAP (“normal MAP”) or an HARQ MAP.

In the OFDM/OFDMA communication system, scheduling, particularly, scheduling in the uplink of the communication system, is performed using the normal MAP or the HARQ MAP. Therefore, there is a need for a new scheduling scheme for determining a transmission format in the uplink of the OFDM/OFDMA communication system, in particular, for determining a transmission format using the HARQ MAP.

### SUMMARY OF THE INVENTION

An aspect of the present invention is to address at least the problems and/or disadvantages and to provide at least the advantages described below. Accordingly, an aspect of the present invention is to provide a scheduling method and apparatus in a communication system.

Another aspect of the present invention is to provide a scheduling method and apparatus for determining a data transmission format for each of MSs in a communication system.

Further another aspect of the present invention is to provide a scheduling method and apparatus for determining a data transmission format of an uplink in a communication system.

According to one aspect of the present invention, there is provided a scheduling method in a communication system. The scheduling method includes determining, by a base station (BS), candidate transmission formats of a plurality of mobile stations (MSs) according to channel status information fed back from the MSs and levels of transmission power of the MSs; and calculating priorities of the determined candidate transmission formats, and determining a transmission format having the highest priority among the candidate transmission formats, as a transmission format for each of the MSs.

According to one aspect of the present invention, there is provided a scheduling apparatus in a communication system. The scheduling apparatus includes a scheduler for determining candidate transmission formats of a plurality of mobile stations (MSs) according to channel status information fed back from the MSs and levels of transmission power of the MSs, calculating priorities of the determined candidate transmission formats, and determining a transmission format having the highest priority among the candidate transmission formats, as a transmission format for each of the MSs.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating the structure of slots and subchannels in a BWA communication system;

FIG. 2 is a chart illustrating the validity check block in a scheduling scheme according to the present invention;

FIG. 3 is a flowchart of the operation of the validity check block for scheduling in a BWA communication system according to the present invention; and

FIG. 4 is a graph illustrating the relationship between a value of α and system performance in a communication system according to the present invention.

### DETAILED DESCRIPTION OF PREFERRED EMBODIMENTS

Preferred embodiments of the present invention will now be described in detail with reference to the annexed drawings. In the following description, detailed description of known functions and configurations incorporated herein has been omitted for clarity and conciseness.

The present invention provides a scheduling method and apparatus in a communication system, for example, Institute of Electrical and Electronics Engineers (IEEE) 802.16 communication system, which is a Broadband Wireless Access (BWA) communication system. Although preferred embodiments of the present invention will be described herein with reference to the IEEE 802.16 communication system employing Orthogonal Frequency Division Multiplexing (OFDM)/Orthogonal Frequency Division Multiple Access (OFDMA), the scheduling method and apparatus proposed in the present invention can also be applied to other communication systems.

In the communication system according to the present invention, a base station (BS) detects a channel status, for example, a Signal-to-Interference and Noise Ratio (SINR), based on Channel Quality Information (CQI) fed back from mobile stations (MSs). The BS controls the system loading according to the detected SINR and transmission power of each of the MSs from which it has received the feedback information. In the communication system according to the present invention, scheduling is performed by estimating the highest SINR through the detected SINR and transmission power of the MSs, calculating priorities of candidate transmission formats corresponding to the estimated highest SINR and system loading, and then determining a transmission format having the highest priority. The term “transmission format” refers to a Modulation and Coding Scheme (MCS) level to be used for providing a communication service to the MSs, and the number of slots to be allocated to each of the MSs.

In addition, the present invention provides a scheduling method and apparatus for determining the transmission format for both instances where the OFDM/OFMDA communication system uses a Hybrid Automatic Repeat reQuest (HARQ) MAP, and where the OFDM/OFMDA communication system uses a non-HARQ MAP (a “normal MAP”).

In the case where the normal MAP is used, scheduling allows the BS to have loading of an appropriate level through the system loading control, thereby satisfying a reference data rate and guaranteeing the coverage, and scans channel variation between the BS and MSs, thereby guaranteeing the fairness and facilitating optimal resource utilization. In other words, the scheduling for the case where the normal MAP is used, detects a channel status through CQIs fed back from the MSs to the BS, and varies an MCS level according to the detected channel status, or adjusts the number of slots allocated to each of the MSs, thereby controlling the loading.

In the case where the HARQ MAP is used, scheduling controls the loading in the same way as done for the case where the normal MAP is used. However, in the case where the HARQ MAP is used, scheduling previously determines transmission formats available for the HARQ MAP, selects one of the determined transmission formats, and allocates resources using the selected transmission format. In other words, in the case where the HARQ MAP is used, scheduling determines if a corresponding transmission format is available for all MCS levels, calculates priorities for the determined transmission formats, and selects a transmission format having the highest priority.

Although preferred embodiments of the present invention will be described herein with reference to a scheduling method and apparatus for the case where the HARQ MAP is used, the present invention can also be applied to a scheduling method and apparatus for the case where the normal MAP is used. In the communication system according to the present invention, for the case where the HARQ MAP is used, a scheduler receives CQI fed back from MSs through a Channel Quality Information Channel (CQICH), and detects the channel status, for example, SINR, of a downlink based on the received CQI. In addition, the scheduler estimates the channel status, especially channel quality of the uplink, by estimating the highest SINR based on transmission power fed back from the MSs, for example, headroom of power during data transmission from the MSs to the BS, and the detected SINR. Thereafter, the scheduler selects an available one of transmission formats supported by the HARQ MAP for every MCS level using the estimated channel status, determines the selected transmission formats as candidate transmission formats, calculates priorities of the determined candidate transmission formats, and transmits data using a transmission format having the highest priority.

The scheduler can be included in the BS that provides a communication service to the MSs, or in a base station controller (BSC) that exists in an upper layer of the BS and controls a plurality of BSs. The scheduler is assumed to be included in the BS. For convenience, a process in which the BS determines candidate transmission formats using the detected channel status, for example, SINR, and transmission power of the MSs will be referred to as a validity check block, and a process in which the BS calculates priorities of the candidated transmission formats determined through the validity check block, and determines the transmission format among the candidate transmission formats according to the calculated priorities will be referred to as a priority compare block. A preferred embodiment of the present invention performs scheduling through the validity check block and the priority compare block.

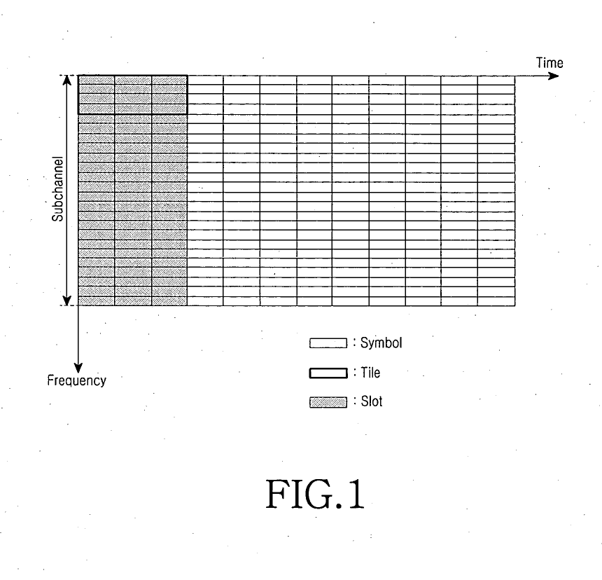

Referring to FIG. 1, in the BWA communication system, data transmission is performed in units of frames, and each frame is divided into a region for transmitting downlink data and a region for transmitting uplink data. The region for transmitting uplink data is formed in a 2-dimensional arrangement of a frequency region versus a time region, and each element of the 2-dimensional arrangement is a slot, which is an allocation unit. That is, for each slot, the frequency region is divided into subchannels, each of which can be a bundle of 24 subcarriers. The time region is divided into 3 symbols, and the slot represents a region where one subchannel occupies 3 symbols. Therefore, in the 2-dimensional arrangement, each frame is composed of 24 subcarriers and 3 symbols. Each slot is allocated to only one MS among the MSs located in one cell, and a set of slots allocated to each of the MSs located in the cell is a burst. In this communication system, uplink wireless resources are allocated in such a manner that slots are separately used by MSs.

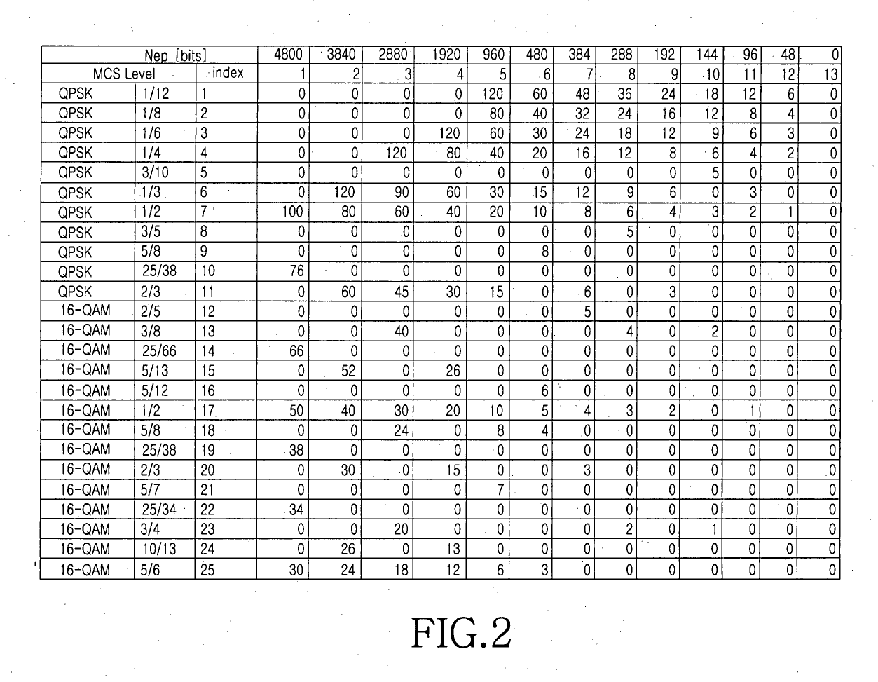

Referring to FIG. 2, there are shown the number Nₑₚ of information bits and MCS levels. Indexes under the number Nₑₚ of information bits, for example, 4800, 3840, 2880, . . . , 48, 0, indicate Nₑₚ index of the number of information bits, and the numbers under the MCS Level label, for example, QPSK 1/12, QPSK 1/8, . . . , 16-QAM 5/6, indicate MCS_index of MCS levels. In addition, the point where the number Nₑₚ of information bits and the MCS level intersects indicates the number of slots necessary for one frame to send data corresponding to the number Nₑₚ of information bits using the particular MCS level. For example, if the MCS level is Quadrature Phase Shift Keying (QPSK) 1/3 and the number Nₑₚ of transmission information bits is 2800, the number of slots necessary for one frame to send Nₑₚ=2880-bit data is 90. In this case, an index MCS_index of the MCS level=QPSK 1/3 is 6, and an index Nₑₚ_{_{—}}index of the number (Nₑₚ=2880) of information bits is 3.

The validity check block selects, as candidate transmission formats, the transmission format that is available for each of MCS levels lower than the maximum allowable MCS level for MSs and has the largest number Nₑₚ of information bits. The maximum allowable MCS level, which is an output value of an interference control apparatus for allowing all MSs to have appropriate loading, is a parameter, which is adjustable according to the amount of interference of a BS. The interference control apparatus is not directly related to the scheduling method and apparatus proposed in the present invention, so a detailed description thereof will be omitted. In addition, the validity check block allows the number Nₑₚ of information bits to satisfy the number Nₑₚ of information bits, which is lower than or equal to the number of data bits that should be transmitted to increase resource efficiency, and selects, as candidate transmission formats, the transmission format having the number of slots, which is lower than the satisfied number Nₑₚ of information bits.

For example, if the maximum allowable MCS level is 16-QAM 1/2, the number of transmission data bits is 3000, and the number of remaining slots is 90 as an interference control result of the interference control apparatus, the validity check block, as shown in FIG. 2, starts finding candidate transmission formats beginning from the number Nₑₚ=2880 of information bits, which is less than the number Nₑₚ=3000 of information bits, for all MCS levels below the maximum allowable MCS level=16-QAM 1/2. Even for the transmission format having the largest number Nₑₚ of information bits, if the number of slots necessary for the corresponding transmission format is greater than the number of allowable slots, the validity check block finds the candidate transmission formats beginning from the next number Nₑₚ of information bits without selecting the corresponding transmission format as a candidate transmission format.

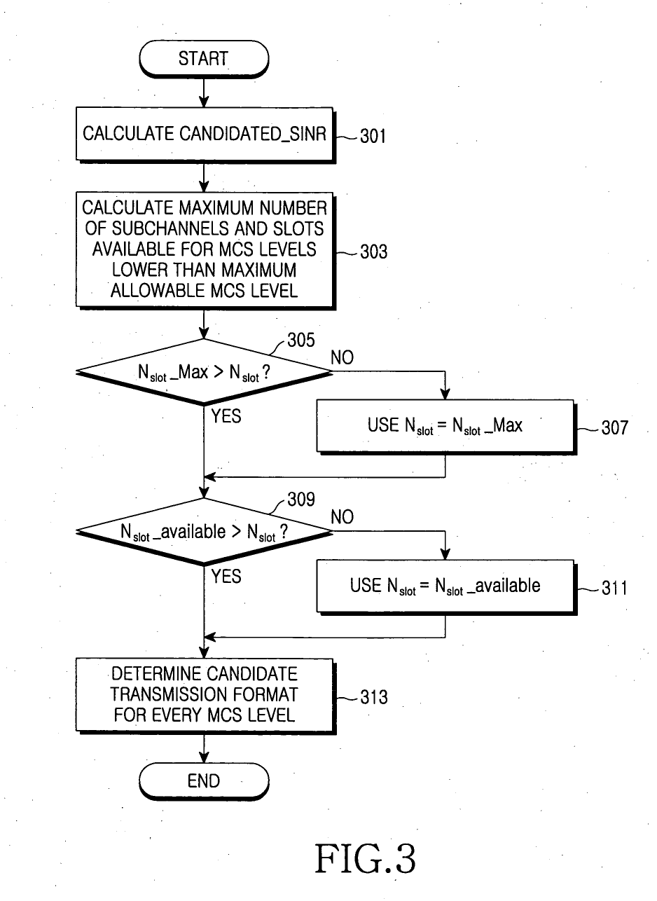

In FIG. 2, the candidate transmission formats selected in this manner include a candidate transmission format of MCS levels QPSK 1/2, QPSK 2/3, 16-QAM 3/8, and 16-QAM 1/2 corresponding to the numbers (Nₛₗₒₜ=60, 45, 40 and 30) of slots for the number Nₑₚ=2800 of information bits, a candidate transmission format of an MCS level QPSK 1/4 corresponding to the number Nₛₗₒₜ=80 of slots for the number of Nₑₚ=1920 of information bits, a candidate transmission format of MCS levels QPSK 1/8 and QPSK 1/6 corresponding to the numbers (Nₛₗₒₜ=80 and 60) of slots for the number of Nₑₚ=960 of information bits, and a candidate transmission format of an MCS level QPSK 1/12 corresponding to the number Nₛₗₒₜ=60 of slots for the number of Nₑₚ=480 of information bits. With reference to FIG. 3, a detailed description will now be made of the validity check block.

Referring to FIG. 3, in step 301, the channel status is detected according to the validity check block, for example, SINR of each of MSs based on CQI fed back from the MSs through a downlink, and estimates of a received SINR, i.e. highest SINR of a symbol received when the MSs transmit symbols with the maximum power using the detected SINR and levels of transmission power of the MSs fed back from the MSs, for example, headroom of the power during data transmission from the MSs to a BS. Herein, the estimated SINR will be referred to as a candidate SINR Candidated_SINR.

Thereafter, in step 303, the maximum number N_{sch} of subchannels and the maximum number Nₛₗₒₜ of slots, available for all MCS levels below the maximum allowable MCS level which is an output value of the interference control apparatus is calculated. More specifically, for all the MCS levels, the validity check block calculates a ratio of the candidate SINR Candidated_SINR estimated when the MSs transmit symbols at the maximum power, to an SINR needed when the MS transmits one symbol at an arbitrary MCS level to be calculated currently among all the MCS levels, and then calculates the maximum number N_{sch} of subchannels available for the MSs by multiplying the calculated ratio by the number N_{sch}_{_{—}}ₚᵣₑᵥ of subchannels that the MSs has used during previous transmission. The maximum number N_{sch} of subchannels is defined in Equation (1) as,

$${N}_{sch} = floor ( {N}_{sch\_prev} \times \frac{Candidated\_SINR}{{SINR}_{req} [ MCS\_index ]} ) \qquad ( 1 )$$

In Equation (1), N_{sch} denotes the maximum number of subchannels available at an MCS level of the current scheduling time, and N_{sch}_{_{—}}ₚᵣₑᵥ denotes the number of subchannels used during previous transmission, i.e. used at a previous scheduling time. In addition, SINR_{req} denotes a threshold of an SINR needed for transmitting symbols at the corresponding MCS level, MCS_index denotes an index of the corresponding MCS level, and ‘floor’ denotes a floor function. Accordingly, SINR_{req}[MCS_index] in Equation (1) means a threshold of an SINR needed for transmitting symbols at a corresponding MCS level for all MCS levels below the maximum allowable MCS level.

After calculating the maximum number of available subchannels using Equation (1), the maximum number of slots available for each of the MSs is calculated according to the validity check block using Equation (2).
Nₛₗₒₜ=N_{sch}×Nₛₗₒₜ_{_{—}}_{frame} (2)

In Equation (2), Nₛₗₒₜ denotes the maximum number of slots available at the current MCS level, N_{sch} denotes the maximum number of subchannels calculated using Equation (1), and Nₛₗₒₜ_{_{—}}_{frame} denotes the total number of slots in one frame. For example, in FIG. 1, the total number Nₛₗₒₜ_{_{—}}_{frame} of slots in one frame is 4.

In step 303, using Equation (1) and Equation (2), the maximum number N_{sch} of subchannels which are available in a frequency range when the MSs transmit symbols with the maximum power is calculated according to the validity check block, and the maximum number Nₛₗₒₜ of slots available in the frequency range and the time range is also calculated by multiplying the calculated maximum number N_{sch} of subchannels by the maximum number of slots allowed for the time axis in one frame.

Thereafter, in step 305, the maximum number Nₛₗₒₜ of slots, calculated in step 303, is compared with the maximum number Nₛₗₒₜ_{_{—}}Max of slots that a scheduler of a BS can allocate to one MS in the communication system according to the validity check block. The maximum number Nₛₗₒₜ_{_{—}}Max of slots allocable to one MS is the maximum value that the scheduler of the communication system can select, and varies according to the maximum number of subchannels allocable to one MS. That is, the maximum number Nₛₗₒₜ_{_{—}}Max of slots allocable to one MS can be calculated using Equation (2). Thus, performance of the communication system is determined according to the maximum number of subchannels allocable to one MS. For example, a decrease in the maximum number of subchannels allocable to one MS reduces the system performance, and if all subchannels are allocated to one MS, the system performance increases but resource efficiency decreases.

If the maximum number Nₛₗₒₜ_{_{—}}Max of allocable slots is greater than the maximum number Nₛₗₒₜ of available slots as a result of comparison in step 305, the procedure advances to step 307 where the calculated maximum number Nₛₗₒₜ of slots as the maximum number Nₛₗₒₜ_{_{—}}Max of allocable slots is used. However, if the maximum number Nₛₗₒₜ_{_{—}}Max of allocable slots is less than or equal to the calculated maximum number Nₛₗₒₜ of available slots as a result of comparison in step 305, the procedure advances to step 309.

In step 309, the calculated maximum number Nₛₗₒₜ of slots is compared with the number Nₛₗₒₜ_{_{—}}available of slots available at the current scheduling time according to the validity check block. If the calculated maximum number Nₛₗₒₜ of slots is greater than the number Nₛₗₒₜ_{_{—}}available of currently available slots as a result of the comparison in step 309, the procedure advances to step 311 where the calculated maximum number Nₛₗₒₜ of slots as the number Nₛₗₒₜ_{_{—}}available of currently available slots is used. However, if the calculated maximum number Nₛₗₒₜ of slots is less than or equal to the number Nₛₗₒₜ_{_{—}}available of currently available slots as a result of the comparison in step 309, the procedure advances to step 313.

In step 313, for all MCS levels below the maximum allowable MCS level, a transmission format having the largest number Nₑₚ of information bits as a candidated transmission format is determined according to the validity check block, with the use of the number of slots, which is less than the calculated maximum Nₛₗₒₜ number of slots, i.e. the maximum number Nₛₗₒₜ of slots available for one MS.

In the communication system according to a preferred embodiment of the present invention, after determining the candidate transmission formats with the use of the validity check block, the scheduler of the BS calculates priorities of the candidate transmission formats and determines a transmission format according to the calculated priorities, with the use of a priority compare block.

The priorities of the candidate transmission formats are calculated using Equation (3).
Priority=Nₑₚ×MPR^{α} (3)

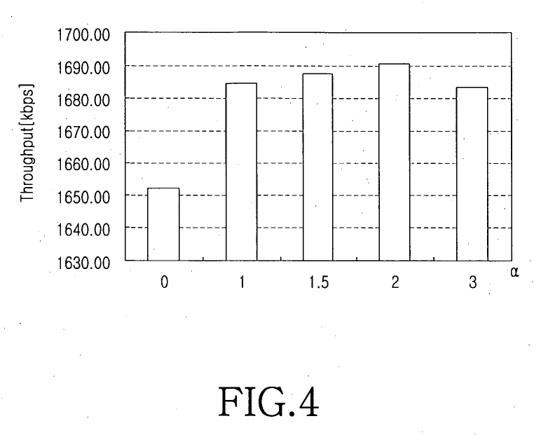

In Equation (3), ‘Priority’ denotes priorities of the candidate transmission formats at each of the MCS levels determined per the validity check block, Nₑₚ denotes the number of information bits, and MPR (Modulation order Product coding Rate) denotes a value obtained by multiplying a modulation order by a coding rate, and is determined depending on MCS level. In addition, α is an exponent of the MPR, and if α approaches 0, there is a high probability that the scheduler will determine a transmission format that has a low MCS level and uses a large number of slots for one MS. However, if α is greater than 1, there is a high probability that the scheduler will select a transmission format that has a high MCS level and uses a small number of slots for one MS. As a result, the scheduler can efficiently control the resource and the system performance by adjusting a value of the α. With reference to FIG. 4, a description will now be made of a relationship between a value of the α and the system performance.

In FIG. 4, the system performance is obtained by changing the value of α from 0 to 3. As shown in FIG. 4, as a approaches 0, the system performance (or throughput) decreases, and if α is greater than 1, the system performance improves. Therefore, it is possible to improve the system performance by adjusting the value of α from 1 to 3.

As can be understood from the foregoing description, in the communication system, the scheduling scheme proposed in the present invention can improve the resource's efficiency and system performance. In addition, the proposed scheduling scheme for determining a transmission format according to channel status, controls system loading thereby guaranteeing the coverage, and detects a variation in channel status between a BS and MSs, thereby guaranteeing fairness and improving the efficiency of the resource and system performance.

While the invention has been shown and described with reference to a certain preferred embodiment thereof, it will be understood by those skilled in the art that various changes in form and details may be made therein without departing from the spirit and scope of the invention as further defined by the appended claims.

What is claimed is:

1. A scheduling method in a communication system, the method comprising:
determining, by a base station (BS), candidate transmission formats of a plurality of mobile stations (MSs) according to channel status information fed back from the MSs and levels of transmission power of the MSs; and
calculating priorities of the determined candidate transmission formats, and determining a transmission format having the highest priority among the candidate transmission formats, as a transmission format for each of the MSs.

2. The scheduling method of claim 1, wherein the determination of candidate transmission formats of the MSs comprises determining, as a candidate transmission format, a transmission format where the number of slots necessary for data transmission is less than the number of available slots for Modulation and Coding Scheme (MCS) levels lower than a maximum allowable MCS level for the MSs.

3. The scheduling method of claim 1, wherein the determination of candidate transmission formats of the MSs comprises detecting a Signal-to-Interference and Noise Ratio (SINR) according to the channel status information, and estimating a candidate SINR using the detected SINR and the level of the transmission power.

4. The scheduling method of claim 3, wherein the candidate SINR is an SINR that the BS receives when the MSs transmit signals with maximum transmission power.

5. The scheduling method of claim 3, wherein the determination of candidate transmission formats of the MSs comprises calculating the maximum number of subchannels available for MCS levels lower than a maximum allowable MCS level for the MSs.

6. The scheduling method of claim 5, wherein the calculation of the maximum number of subchannels comprises calculating the maximum number of subchannels using the following equation:
$${N}_{sch} = floor ( {N}_{sch\_prev} \times \frac{Candidated\_SINR}{{SINR}_{req} [ MCS\_index ]} )$$
where N_{sch} denotes the maximum number of subchannels, calculated at the current scheduling time, N_{sch}_{_{—}}ₚᵣₑᵥ denotes the number of subchannels used at a previous scheduling time, Candidated_SINR denotes the candidate SINR, SINR_{req}[MCS_index] denotes a threshold of an SINR needed for transmitting a signal at an MCS level lower than the maximum allowable MCS level, and ‘floor’ denotes a floor function.

7. The scheduling method of claim 6, wherein the calculation of the maximum number of subchannels comprises calculating the maximum number of slots using the following equation:
Nₛₗₒₜ=N_{sch}×Nₛₗₒₜ_{_{—}}_{frame}
where Nₛₗₒₜ denotes the maximum number of slots available at an MCS level of the current scheduling time, N_{sch} denotes the calculated maximum number of subchannels, and Nₛₗₒₜ_{_{—}}_{frame} denotes the total number of slots in one frame.

8. The scheduling method of claim 7, wherein the determination of candidate transmission formats of the MSs comprises determining, as a candidate transmission format, a transmission format that uses a number of slots, which is less than the calculated maximum number of slots, for MCS levels lower than the maximum allowable MCS level.

9. The scheduling method of claim 7, wherein the determination of candidate transmission formats of the MSs comprises comparing the calculated maximum number of slots with the maximum number of slots allocable to one MS among the MSs, and then comparing the calculated maximum number of slots with the number of slots available at the current scheduling time.

10. The scheduling method of claim 9, wherein the comparison of the calculated maximum number of slots with the maximum number of slots allocable to one MS among the MSs comprises:
setting the maximum number of allocable slots as the maximum number of slots available for MSs, if the calculated maximum number of slots is greater than the maximum number of allocable slots; and
setting the calculated maximum number of slots as the maximum number of slots available for the MSs, if the calculated maximum number of slots is less than or equal to the maximum number of allocable slots.

11. The scheduling method of claim 10, wherein the determination of candidate transmission formats of the MSs comprises determining, as a candidate transmission format, a transmission format that uses a number of slots, which is less than the maximum number of slots available for the MSs, for MCS levels lower than the maximum allowable MCS level.

12. The scheduling method of claim 9, wherein the comparison of the calculated maximum number of slots with the number of slots available at the current scheduling time comprises:
setting the number of slots available at the current scheduling time as the maximum number of slots available for the MSs, if the calculated maximum number of slots is greater than the number of slots available at the current scheduling time; and
setting the calculated maximum number of slots as the maximum number of slots available for the MSs, if the calculated maximum number of slots is less than or equal to the number of slots available at the current scheduling time.

13. The scheduling method of claim 12, wherein the determination of candidate transmission formats of the MSs comprises determining, as a candidate transmission format, a transmission format that uses a number of slots, which is less than the maximum number of slots available for the MSs, for MCS levels lower than the maximum allowable MCS level.

14. The scheduling method of claim 1, wherein the calculation of priorities of the determined candidate transmission formats comprises calculating priorities according to the number of information bits of the determined candidate transmission formats, and a modulation order and a coding rate given in a maximum allowable MCS level for the MSs.

15. The scheduling method of claim 1, wherein the transmission format comprises a maximum allowable MCS level for the MSs, and the number of slots allocable to the MSs.

16. A scheduling apparatus in a communication system, the apparatus comprising:
a scheduler for determining candidate transmission formats of a plurality of mobile stations (MSs) according to channel status information fed back from the MSs and levels of transmission power of the MSs, calculating priorities of the determined candidate transmission formats, and determining a transmission format having the highest priority among the candidate transmission formats, as a transmission format for each of the MSs.

17. The scheduling apparatus of claim 16, wherein the scheduler determines, as a candidate transmission format, a transmission format where the number of slots necessary for data transmission is less than the number of available slots for Modulation and Coding Scheme (MCS) levels lower than a maximum allowable MCS level for the MSs.

18. The scheduling apparatus of claim 16, wherein the scheduler detects a Signal-to-Interference and Noise Ratio (SINR) according to the channel status information, and estimates a candidate SINR using the detected SINR and the level of the transmission power.

19. The scheduling apparatus of claim 18, wherein the candidate SINR is an SINR that the BS receives when the MSs transmit signals with maximum transmission power.

20. The scheduling apparatus of claim 18, wherein the scheduler calculates the maximum number of subchannels available for MCS levels lower than a maximum allowable MCS level for the MSs.

21. The scheduling apparatus of claim 20, wherein the scheduler calculates the maximum number of subchannels using the following equation:
$${N}_{sch} = floor ( {N}_{sch\_prev} \times \frac{Candidated\_SINR}{{SINR}_{req} [ MCS\_index ]} )$$
where N_{sch} denotes the maximum number of subchannels, calculated at the current scheduling time, N_{sch}_{_{—}}ₚᵣₑᵥ denotes the number of subchannels used at a previous scheduling time, Candidated_SINR denotes the candidate SINR, SINR_{req}[MCS_index] denotes a threshold of an SINR needed for transmitting a signal at an MCS level lower than the maximum allowable MCS level, and ‘floor’ denotes a floor function.

22. The scheduling apparatus of claim 21, wherein the scheduler calculates the maximum number of slots using the following equation:
Nₛₗₒₜ=N_{sch}×Nₛₗₒₜ_{_{—}}_{frame}
where Nₛₗₒₜ denotes the maximum number of slots available at an MCS level of the current scheduling time, N_{sch} denotes the calculated maximum number of subchannels, and Nₛₗₒₜ_{_{—}}_{frame} denotes the total number of slots in one frame.

23. The scheduling apparatus of claim 22, wherein the scheduler determines, as a candidate transmission format, a transmission format that uses a number of slots, which is less than the calculated maximum number of slots, for MCS levels lower than the maximum allowable MCS level.

24. The scheduling apparatus of claim 22, wherein the scheduler compares the calculated maximum number of slots with the maximum number of slots allocable to one MS among the MSs, and then compares the calculated maximum number of slots with the number of slots available at the current scheduling time.

25. The scheduling apparatus of claim 24, wherein the scheduler
sets the maximum number of allocable slots as the maximum number of slots available for MSs, if the calculated maximum number of slots is greater than the maximum number of allocable slots; and
sets the calculated maximum number of slots as the maximum number of slots available for the MSs, if the calculated maximum number of slots is less than or equal to the maximum number of allocable slots.

26. The scheduling apparatus of claim 25, wherein the scheduler determines, as a candidate transmission format, a transmission format that uses a number of slots, which is less than the maximum number of slots available for the MSs, for MCS levels lower than the maximum allowable MCS level.

27. The scheduling apparatus of claim 24, wherein the scheduler:
sets the number of slots available at the current scheduling time as the maximum number of slots available for the MSs, if the calculated maximum number of slots is greater than the number of slots available at the current scheduling time; and
sets the calculated maximum number of slots as the maximum number of slots available for the MSs, if the calculated maximum number of slots is less than or equal to the number of slots available at the current scheduling time.

28. The scheduling apparatus of claim 27, wherein the scheduler determines, as a candidate transmission format, a transmission format that uses a number of slots, which is less than the maximum number of slots available for the MSs, for MCS levels lower than the maximum allowable MCS level.

29. The scheduling apparatus of claim 16, wherein the scheduler calculates priorities according to the number of information bits of the determined candidate transmission formats, and a modulation order and a coding rate given in a maximum allowable MCS level for the MSs.

30. The scheduling apparatus of claim 16, wherein the transmission format comprises a maximum allowable MCS level for the MSs, and the number of slots allocable to the MSs.
